(19) United States
(12) Patent Application Publication
(10) Pub. No.: US 2026/0075316 A1
(43) Pub. Date: Mar. 12, 2026

(54) APPARATUS, METHOD OF CONTROLLING THE SAME, AND STORAGE MEDIUM

(71) Applicant: CANON KABUSHIKI KAISHA, Tokyo (JP)

(72) Inventors: HIROTARO KIKUCHI, Tokyo (JP); YUKI YOSHIMURA, Tokyo (JP)

(21) Appl. No.: 19/295,031

(22) Filed: Aug. 8, 2025

(30) Foreign Application Priority Data
Sep. 6, 2024 (JP) 2024-153659

(51) Int. Cl. H04N 23/67; H04N 23/667; H04N 23/745

(52) U.S. Cl. CPC H04N 23/675; H04N 23/745; H04N 23/667

(57) ABSTRACT

An apparatus includes one or more processors that execute a program stored in a memory and thereby function as a calculation unit configured to calculate depth difference information between a plurality of objects, and a depth control unit configured to control an aperture based on the depth difference information, wherein the depth control unit switches a aperture control method based on whether a temporal change in the depth difference information is in an oscillatory state.

### BACKGROUND

### Field of the Technology

The aspect of the embodiments relates to an apparatus, a method of controlling the apparatus, and a storage medium.

### Description of the Related Art

To image a plurality of object different in position in a depth direction or an object extended in the depth direction, an aperture of a lens device is generally often stopped down (aperture value (F-number) is increased) in order to increase a depth of field. Further, there is discussed a technique for controlling an aperture of an imaging optical system such that a plurality of dynamic objects is within a predetermined depth of field, based on positional information on the plurality of dynamic objects in a depth direction (Japanese Patent Application Laid-Open No. 2018-064285).

In a case where imaging is performed such that a plurality of moving objects is within a depth of field, the objects do not necessarily move in a similar manner in a focus direction. In the technique discussed in Japanese Patent Application Laid-Open No. 2018-064285, a focus target distance is determined such that the plurality of dynamic objects is captured within a predetermined depth of field, based on information on a predicted rear distance and information on a predicted front distance, and then, an aperture value at which the front position and the rear position are within the predetermined depth of field is determined. Therefore, in a case where the focus target distance or the aperture value changes in an oscillatory manner, a temporal change in a depth difference among the plurality of objects or the focus position becomes oscillatory, and there is a concern that the quality of an acquired still image or moving image may be degraded due to focus tracking, flickering of luminance, and the like.

### SUMMARY

According to an aspect of the embodiments, an apparatus includes one or more processors that execute a program stored in a memory and thereby function as a calculation unit configured to calculate depth difference information between a plurality of objects, and a depth control unit configured to control an aperture based on the depth difference information, wherein the depth control unit switches a aperture control method based on whether a temporal change in the depth difference information is in an oscillatory state.

Features of the disclosure will become apparent from the following description of embodiments with reference to the attached drawings. The following description of embodiments is described by way of example.

### BRIEF DESCRIPTION OF THE DRAWINGS

FIG. 1 a block diagram illustrating a configuration of a digital camera.

FIG. 2 is a block diagram illustrating an electric configuration of the digital camera.

FIG. 3 is a conceptual diagram illustrating an example of pixel arrangement in an imaging element.

FIGS. 4A and 4B are respectively a schematic plan view and a schematic cross-sectional view of pixels.

FIG. 5 is a diagram illustrating a focus detection area.

FIG. 6 is a flowchart illustrating focus detection processing.

FIG. 7 is a diagram illustrating a state where a main object and a sub object are detected.

FIG. 8 is a diagram illustrating a state where a main object and sub objects are detected.

FIG. 9 is a conceptual diagram illustrating a temporal change in a defocus amount of each object.

FIG. 10 is a conceptual diagram illustrating a temporal change in a depth difference between objects and a focus lens position.

FIGS. 11A and 11B are conceptual diagrams illustrating temporal changes in accelerations of the depth difference between the objects and the focus lens position.

FIG. 12 is a flowchart illustrating switching processing of a depth control method and a focus control method.

FIG. 13 is a diagram illustrating a display example of a menu screen of a camera, which is used to designate an imaging mode.

### DESCRIPTION OF THE EMBODIMENTS

The disclosure is described in detail below using exemplary embodiments with reference to accompanying drawings.

The following exemplary embodiment are not intended to limit the disclosure as set forth in the claims. Although a plurality of features is described in the exemplary embodiment, all of the features are not necessarily essential for the disclosure, and the plurality of features may be optionally combined. In the accompanying drawings, the same or similar components are denoted by the same reference numerals, and repetitive description is omitted.

In the following exemplary embodiment, a case where the disclosure is implemented in an imaging apparatus, such as a digital camera, is described. However, an imaging function is not essential for the aspect of the embodiments, and the aspect of the embodiments can be implemented in an optional imaging apparatus. Such an imaging apparatus includes a mobile phone, a smartphone, a game machine, a robot, a drone, and a drive recorder. These are illustrative, and the aspect of the embodiments can be implemented in other imaging apparatuses.

### <Overall Configuration>

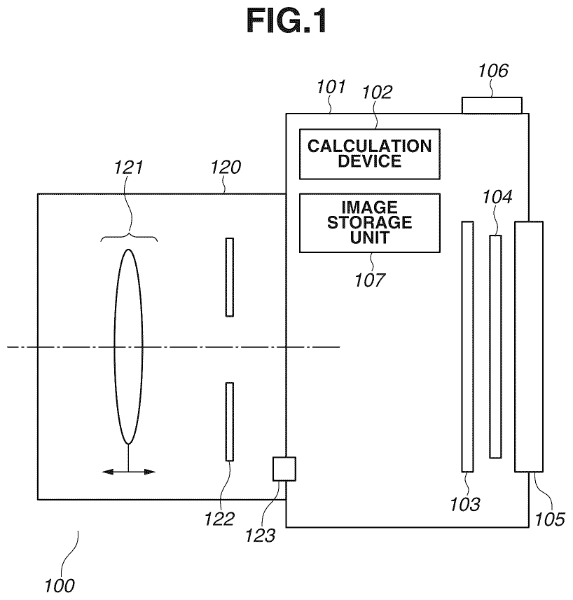

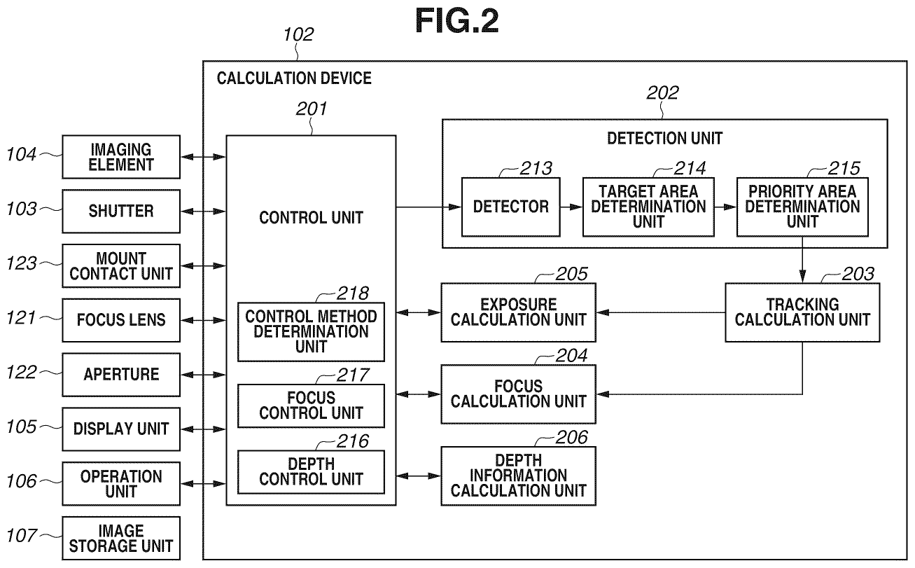

FIG. 1 illustrates an example of a configuration of a digital camera (hereinafter, also simply referred to as camera) 100 as an example of the imaging apparatus according to the exemplary embodiment. FIG. 2 is a block diagram illustrating an electric configuration of the camera 100 illustrated in FIG. 1.

As illustrated in FIG. 1, in the camera 100, a detachable interchangeable lens unit 120 is mounted on a front side (object side) of a camera main body 101. The lens unit 120 includes a focus lens 121 and an aperture 122, and is electrically connected to the camera main body 101 through a mount contact unit 123. This makes it possible to adjust a light quantity to be taken into the camera main body 101 and a focus position. The focus lens 121 can be manually adjusted by a user.

An imaging element 104 is configured using a complementary metal-oxide semiconductor (CMOS) sensor or the like, and includes an infrared cut filter and a lowpass filter. The imaging element 104 photoelectrically converts an object image that passes through an imaging optical system of the lens unit 120 and is formed in imaging, and transmits a signal for generating a captured image to a calculation device 102. The calculation device 102 generates a captured image from the received signal, stores the captured image in an image storage unit 107, and displays the captured image on a display unit 105, such as a liquid crystal display (LCD). A shutter 103 shields the imaging element 104 when imaging is not performed, and opens to expose the imaging element 104 when imaging is performed.

Next, a configuration relating to control is described with reference to FIG. 2. The calculation device 102 includes a multicore central processing unit (CPU) that can process a plurality of tasks in parallel, a random access memory (RAM), a read only memory (ROM), a dedicated circuit for performing specific calculation processing at a high speed, and the like. With the hardware, the calculation device 102 constitutes a control unit 201, a detection unit 202, a tracking calculation unit 203, a focus calculation unit 204, and an exposure calculation unit 205. The control unit 201 (including an exposure control unit (not illustrated), a focus control unit 217, a depth control unit 216, and a control method determination unit 218 according to exemplary embodiment) controls each of units of the camera main body 101 and the lens unit 120.

The detection unit 202 includes a detector 213, a target area determination unit 214, and a priority area determination unit 215. The detector 213 performs processing for detecting a specific area (e.g., the face and eyes of a person, and the face and eyes of an animal) from an image. The specific area may not be detected, or a plurality of specific areas may be detected. A detector for the eyes of a person or an animal is included in the detector 213. As a detection method, an optional known method, such as AdaBoost and convolutional neural network, may be used. An implementation form thereof may be a program operating in the CPU, dedicated hardware, or a combination thereof.

An object detection result obtained from the detector 213 is transmitted to the target area determination unit 214. The target area determination unit 214 selects one or more detected object parts and determines the selected object parts as target areas to be used for depth priority control described below. The target areas are determined using a known calculation method based on types, sizes, and positions of the detected object parts, the reliability of the detection result, and the like. The target areas can also be determined based on, in addition to the object parts detected by the detector 213, a past detection result, a feature amount such as the edge of a target frame, defocus information on an object (also referred to as information about an object distance).

The priority area determination unit 215 determines a priority order of each of the target areas determined by the target area determination unit 214. Regarding the priority order, only a target area having the highest priority may be determined, or a priority may be assigned to each of the target areas.

The tracking calculation unit 203 performs target area tracking processing based on detection information on the target areas. As a tracking method, a known method, such as template matching, in which feature amounts of frames are compared, may be used.

The focus calculation unit 204 calculates defocus information to focus on an object.

The exposure calculation unit 205 calculates control values, such as an aperture value of the aperture 122, International Organization for Standardization (ISO) sensitivity of the imaging element 104, a control value for the shutter 103, and the like, to properly expose a main target area. A specific example of calculation of the control values is described. In a case where the aperture 122 is controlled to a small value, a control value to reduce an amplification amount (gain amount) of a signal for generating a captured image to be obtained by the imaging element 104 is calculated in order to properly control exposure. Further, a control value to reduce a time when the shutter 103 is opened (to increase the shutter speed) is calculated. In a case where the aperture 122 is controlled to a large value, a control value to increase the gain amount is calculated in order to property control exposure. Further, a control value to reduce the shutter speed is calculated.

A depth information calculation unit 206 acquires the defocus information, and calculates positional information in a depth direction from the camera to an object as depth information. In addition, the depth information calculation unit 206 calculates a positional difference between a plurality of objects in the depth direction, as depth difference information, based on the calculated positional information. In the exemplary embodiment, the depth information is calculated using the defocus amount calculated by a phase difference detection method, but can be acquired using a depth sensor that acquires depth information by using reflection of a laser beam, such as a light detection and ranging (LiDAR) sensor. The depth information may be acquired using an optional known method.

The control unit 201 receives results from the detection unit 202, the exposure calculation unit 205, and the focus calculation unit 204, and then controls the focus lens 121, the aperture 122, the display unit 105, and the like. The control unit 201 includes the depth control unit 216. In a case where a plurality of target areas is set by the detection unit 202, the depth control unit 216 determines whether the plurality of target areas can be captured within a specific depth, by using the depth information from the depth information calculation unit 206. In a case where the plurality of target areas can be captured within the specific depth, the depth control unit 216 calculates control values for the focus lens 121 and the aperture 122. The aperture 122 is controlled based on the calculated control value. Further, in response to a control result, the display unit 105 displays a frame indicating focusing, non-focusing, and the like with respect to an object on a display screen. The specific depth generally indicates a depth of field, but may be a depth optionally set. Further, the object captured within the specific depth (depth of field) is defined to be in focus.

The control unit 201 further includes the focus control unit 217. The focus control unit 217 calculates a focus control value by using the defocus information from the focus calculation unit 204 and the depth information from the depth information calculation unit 206, and then, controls the focus lens 121.

The control unit 201 further includes the control method determination unit 218. The control method determination unit 218 determines control methods of the depth control unit 216 and the focus control unit 217.

An operation unit 106 includes a release switch, a mode dial, and the like. The control unit 201 can receive an imaging instruction, a mode change instruction, and the like from the user via the operation unit 106.

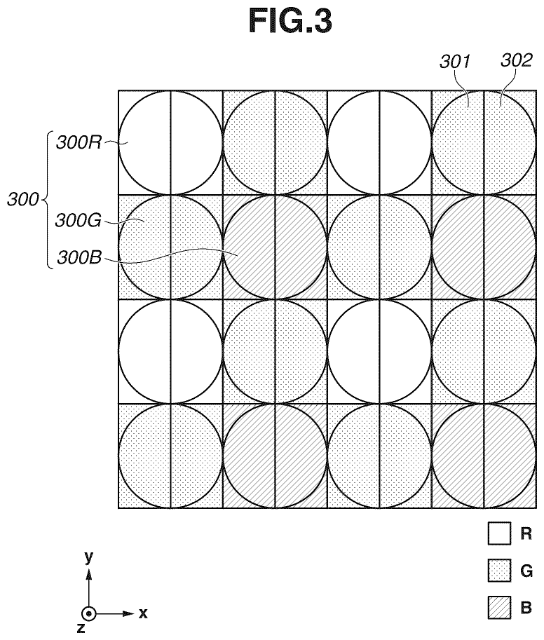

Next, pixel arrangement in the imaging element 104 is described with reference to FIG. 3. FIG. 3 illustrates pixel arrangement in a range of four columns×four rows among pixels (imaging pixels) which form the imaging element 104, as viewed in an optical axis direction (z direction).

One pixel group 300 includes four imaging pixels arranged in two rows×two columns. By arranging a large number of pixel groups 300 in the imaging element 104, photoelectric conversion of a two-dimensional object image can be performed. In each of the pixel groups 300, an imaging pixel 300R having red (R) spectral sensitivity (hereinafter, referred to as “R pixel”) is disposed on the upper left, and an imaging pixel 300G having green (G) spectral sensitivity (hereinafter, referred to as “G pixel”) is disposed on each of the upper right and lower left. Further, an imaging pixel 300B having blue (B) spectral sensitivity (hereinafter, referred to as “B pixel”) is disposed on the lower right. Each of the imaging pixels includes a first focus detection pixel 301 and a second focus detection pixel 302 that are divided in a horizontal direction (x direction).

In the exemplary embodiment, a case where each of the imaging pixels is divided into two portions in the horizontal direction is described, but each of the imaging pixels may be divided in a vertical direction. The imaging element 104 according to the exemplary embodiment includes the plurality of imaging pixels each including the first and second focus detection pixels; however, the imaging pixels and the first and second focus detection pixels may be provided as separate pixels. For example, the first and second focus detection pixels may be discretely arranged in the plurality of imaging pixels.

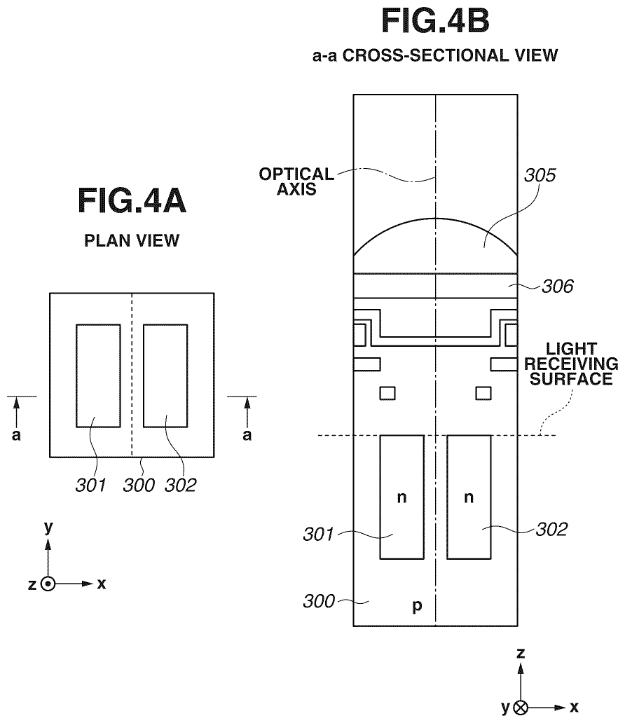

FIG. 4A illustrates one imaging pixel (300R, 300G, or 300B) as viewed from a light receiving surface side (+z direction) of the imaging element 104. FIG. 4B is a cross-sectional view of an a-a cross-section of the imaging pixel illustrated in FIG. 4A as viewed in a −y direction. As illustrated in FIG. 4B, one microlens 305 for condensing incident light is provided in each of the imaging pixels.

Further, each of the imaging pixels includes photoelectric conversion units 301 and 302 divided into N portions (in exemplary embodiment, divided into two portions) in the x direction. The photoelectric conversion units 301 and 302 respectively correspond to the first focus detection pixel 301 and the second focus detection pixel 302. The centroids of the photoelectrical conversion units 301 and 302 are respectively eccentric to a −x side and a +x side from an optical axis of the microlens 305.

An R, G, or B color filter 306 is provided between the microlens 305 and the photoelectric conversion units 301 and 302 in each of the imaging pixels. A spectral transmittance of the color filter may be changed for each photoelectric conversion unit, or the color filter may be omitted.

The light having entered each of the imaging pixels through the imaging optical system is condensed by the microlens 305, spectrally separated by the color filter 306, and then received and photoelectrically converted by the photoelectric conversion units 301 and 302.

In each of the pixels having such a configuration, a signal (A+B signal) obtained by adding signals from the photoelectric conversion units 301 and 302 is used as an imaging signal, and two signals (A signal and B signal) read out from the respective photoelectric conversion units 301 and 302 are used as paired focus detection signals. Although the imaging signal and the focus detection signals may be both read out, the following operation may be performed in consideration of a processing load. The imaging signal (A+B signal) and the focus detection signal (e.g., A signal) of one of the photoelectric conversion units 301 and 302 are read out, and a difference therebetween is calculated to acquire the other focus detection signal (e.g., B signal) having parallax. Alternatively, the focus detection signals (A signal and B signal) may be separately read out and added to acquire the imaging signal (A+B signal).

The camera 100 including the imaging element 104 that is formed by the pixels illustrated in FIGS. 3, 4A, and 4B can detect a phase difference from the signal sequence of the above-described paired focus detection signals, namely, can perform phase difference focus detection by using a known technique (e.g., Japanese Patent Application Laid-Open No. 2023-95509).

By the phase difference focus detection, a defocus amount of a predetermined area within an imaging range and a defocus direction can be detected.

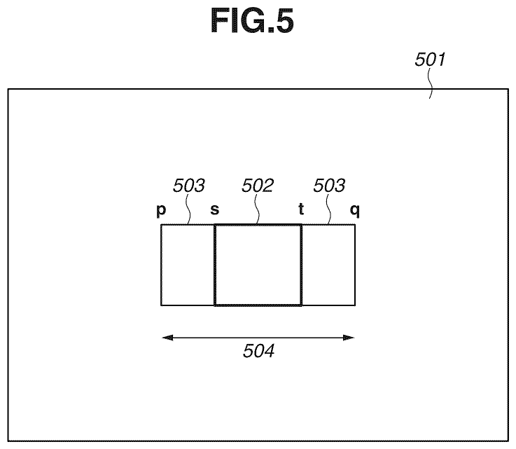

Next, a focus detection area, which is an area where the signal sequence of the paired focus detection signals for detecting a phase difference are acquired in the imaging element 104, is described with reference to FIG. 5. Shift areas 503 on both sides of a focus detection area 502 set in an effective pixel area 501 of the imaging element 104 are areas used for correlation calculation. Therefore, a pixel area 504 including the focus detection area 502 and the shift areas 503 is a pixel area used for correlation calculation. In FIG. 5, reference signs p, q, s, and t each indicate a coordinate in the horizontal direction (x-axis direction), the reference signs p and q respectively indicate x coordinates of a start point and an end point of the pixel area 504, and the reference sings s and t respectively indicate x coordinates of a start point and an end point of the focus detection area 502.

### <Description of Focus Detection Processing>

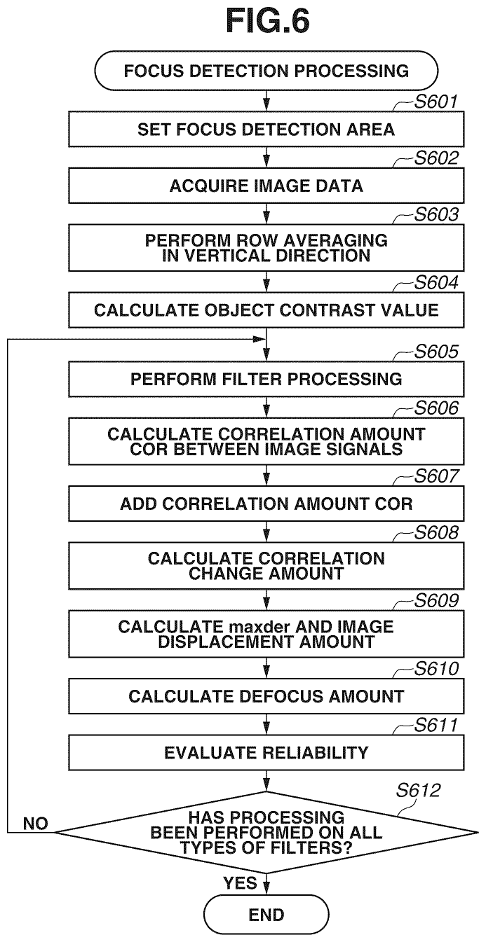

Next, the focus detection processing is described with reference to a flowchart in FIG. 6.

In step S601, the focus calculation unit 204 sets an optional focus detection area 502 (see FIG. 5) based on the focus detection areas 502 two-dimensionally arranged within the imaging screen. The processing then proceeds to step S602.

In step S602, the focus calculation unit 204 acquires paired (two) image signals for focus detection (A image and B image) from the imaging element 104, for the set focus detection area 502.

In step S603, the focus calculation unit 204 performs row-wise summation averaging on the acquired paired image signals in the vertical direction in order to reduce the influence of noise.

The vertical direction here indicates an extending direction of a vertical signal line (vertical transmission path) of the imaging element 104. In the exemplary embodiment, the number of rows to be added in the vertical direction is reduced in a case where calculation processing is to be performed at high speed, such as a continuous shooting mode or the like, and the number of rows to be added in the vertical direction is increased in scenes with noticeable signal noise such as a scene in a dark place. The processing then proceeds to step S604.

In step S604, the focus calculation unit 204 calculates an object contrast value CNT defined by the following equation (1):

CNT=(Peak−Bottom)/Peak. (1)

In the equation, Peak is a variable indicating a maximum value (maximum output value) of a waveform processed using summation averaging in the vertical direction, and Bottom is a variable indicating a minimum value (minimum output value) of the waveform processed using summation averaging in the vertical direction. The focus calculation unit 204 calculates the object contrast value CNT by dividing a difference between the maximum value and the minimum value of the waveform processed using summation averaging in the vertical direction, by the maximum value, as expressed by the equation (1). The object contrast value CNT is used to evaluate reliability of the defocus amount.

In step S605, the focus calculation unit 204 performs filter processing for extracting signal components in a predetermined frequency band from the signals processed using row-wise summation averaging in the vertical direction in step S603. In the exemplary embodiment, three types of filters different in extraction frequency band (low frequency band filter, intermediate frequency band filter, and high frequency band filter) are previously prepared. Among the defocus amounts calculated using the respective filters, the defocus amount to be used is switched based on the degree of blur of the object or the like. When the low frequency band filter is used, ranging performance (defocus amount calculation performance) is increased for a largely blurred object having a collapsed edge. When the high frequency band filter is used, ranging can be performed with high accuracy near a focal point where the edge of the object is clear (i.e., the calculation accuracy of the defocus amount can be increased). The configuration is not limited to the configuration using the three types of filters, and a configuration using at least one or more types of filters may be used.

In step S606, the focus calculation unit 204 calculates a correlation amount COR between the acquired paired (two) image signals (i.e., signal components in the predetermined frequency band extracted by filter processing). In the exemplary embodiment, the calculation is referred to as “correlation calculation”. The focus calculation unit 204 performs the correlation calculation on each of scanning lines after averaging in the vertical direction in the focus detection area.

In step S607, the focus calculation unit 204 adds a waveform of the correlation amount COR in the focus detection area.

In step S608, the focus calculation unit 204 calculates a correlation change amount from the correlation amount COR.

In step S609, the focus calculation unit 204 calculates a displacement amount p between the two images (A image and B image) based on the calculated correlation change amount. Further, the focus calculation unit 204 calculates a steepness of the correlation change amount (hereinafter, referred to as maxder).

In step S610, the focus calculation unit 204 calculates a defocus amount d by multiplying the displacement amount between the two images calculated in step S609, by a predetermined conversion coefficient k. The conversion coefficient k used at this time is a coefficient determined based on the aperture value, an exit pupil distance of the lens, individual information about the imaging element, and a coordinate where the focus detection area 502 is set, and is previously stored in the ROM (not illustrated). Thereafter, the focus calculation unit 204 performs normalization by dividing the calculated defocus amount d by the aperture value and a permissible circle of confusion δ. As a result, the focus displacement amount can be evaluated with the same index even if the aperture value varies.

In step S611, the focus calculation unit 204 evaluates reliability of the defocus amount d calculated in step S610 based on the maxder (steepness) calculated in step S609. Details of the reliability evaluation processing in step S611 are described below.

In step S612, the focus calculation unit 204 determines whether the processing in steps S605 to S611 has been performed on all prepared three types of filters. The three types of filters here are the low frequency band filter, the intermediate frequency band filter, and the high frequency band filter. In a case where there is a filter on which the processing has not been performed (NO in step S612), the processing returns to step S605, and the processing in steps S605 to S611 is performed on the filter on which the processing has not been performed. In a case where the processing has been performed on all three types of filters (YES in step S612), the focus detection processing ends.

### <Description of Depth Control>

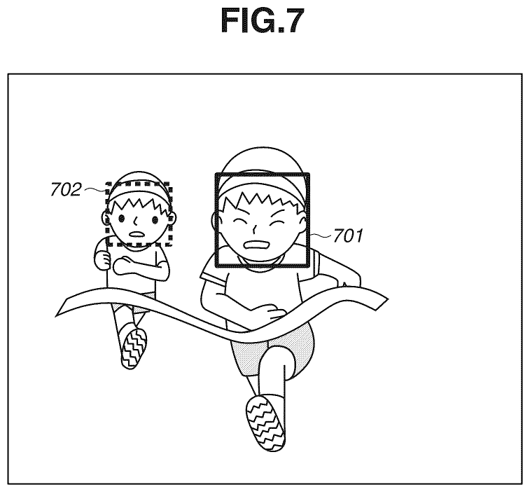

Next, a method of controlling the depth by controlling the aperture such that the plurality of detected objects or the plurality of detected object parts are within the same depth is described with reference to FIG. 7. FIG. 7 illustrates a state where a main object 701 and a sub object 702 are detected. First, a defocus amount is acquired as depth information on each object. In the example illustrated in FIG. 7, a defocus amount Def1 of the object 701 and a defocus amount Def2 of the object 702 are acquired.

A difference between the defocus amounts is calculated as a depth difference DefRange between the objects, and an aperture value F at which the depth difference is within a predetermined depth difference is calculated. As the predetermined depth difference, for example, ±Fδ that is a product of the aperture value F and the permissible circle of confusion δ is set. At this time, the aperture value F at which the main and sub objects are within a range of the depth difference ±1Fδ is calculated to satisfy the following equation (2):

DefRange=|Def1−Def2|=1Fδ. (2)

In the exemplary embodiment, the case of two objects is described as an example; however, the number of objects is not limited. In a case of three or more objects, the aperture value F may be determined, for example, such that the object with the maximum defocus amount and the object with the minimum defocus amount are within the same depth.

### <Description of Control of Focus Lens Position>

Control of a focus lens position is described with reference to FIG. 7. To capture the plurality of detected objects or the plurality of detected object parts within the same depth of field by minimum aperture control, in one embodiment, the focus lens position is controlled to the midpoint of the depth difference that is a focus center position between the objects.

Therefore, the defocus amount Def1 of the object 701 and the defocus amount Def2 of the object 702 are acquired, and a defocus amount DefCenter for controlling the focus lens position to the focus center position (the midpoint of the depth difference) is calculated using the following equation (3):

DefCenter=(Def1+Def2)/2. (3)

In the exemplary embodiment, the case of two objects is described as an example; however, the number of objects is not limited. In a case of three or more objects, the focus lens position may be controlled to, for example, a focus center position between the object with the maximum defocus amount and the object with the minimum defocus amount.

<Adverse Effect when Aperture Value or Focus Lens Position Changes in an Oscillatory/Vibratory Manner>

In a case of imaging in which the plurality of moving objects is to be captured within a depth of field, the depth difference and the focus center among the plurality of objects easily change in a vibratory manner because the objects do not move in a similar manner in a focus direction.

In a case where the temporal change in the depth difference among the plurality of objects exhibits oscillatory behavior, alternately shifting between a deep state and a shallow state, the aperture value to cause the plurality of objects to fall within the depth of field changes in an oscillatory manner. When the aperture value changes in an oscillatory manner, there is a concern that luminance may flicker, and the quality of a still image and a moving image may be degraded.

Further, in a case where the temporal change in the focus center position among the plurality of objects exhibits oscillatory behavior, alternately shifting between a closest distance side and an infinite distance side, when the focus lens position is continuously adjusted to the focus center position, the focus lens position changes in a vibratory manner. When the focus lens position changes in a vibratory manner, there is a concern that the degree of blur in the background and on the closest distance side varies in a vibratory manner, and the quality of a still image and a moving image may be degraded in particular in a case of a bright aperture value.

Therefore, in the exemplary embodiment, to suppress quality degradation in a still image and a moving image caused by the above-described vibration state, the following operation is performed.
(1) Switching of a depth control method by detection of the vibration state of the depth difference
(2) Switching of a focus lens position control method by detection of the vibration state of the focus lens position

### <Detection of Vibration State>

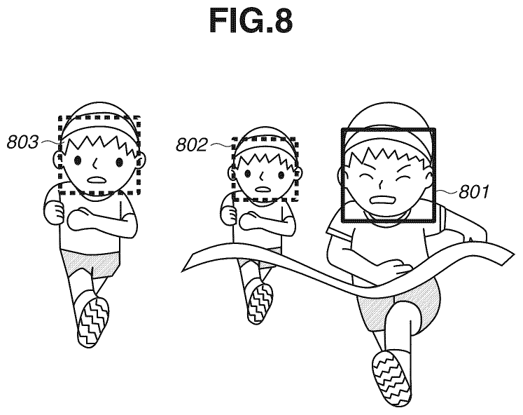

A method of detecting the vibration states of the depth difference and the focus lens position is described with reference to FIGS. 8 to 12.

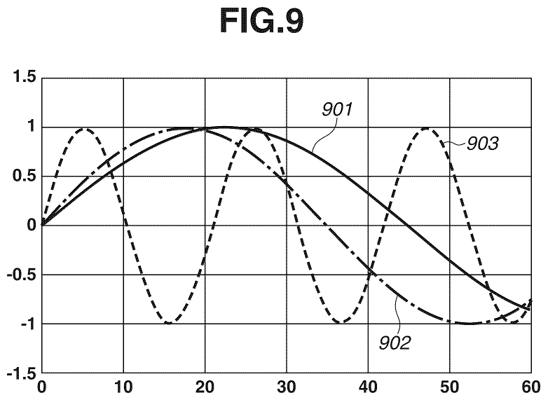

First, temporal changes in defocus amounts of the plurality of detected objects are calculated. FIG. 8 illustrates a state where a main object 801, a sub object 802, and a sub object 803 are detected. FIG. 9 is a conceptual diagram illustrating temporal changes in defocus amounts of the detected objects. In FIG. 9, a defocus amount 901 corresponds to the defocus amount of the main object 801, a defocus amount 902 corresponds to the defocus amount of the sub object 802, and a defocus amount 903 corresponds to the defocus amount of the sub object 803. A defocus amount at time T=t+Δt after a predetermined time Δt is elapsed from the current time T=t is predicted using an equation (4) from a time history information on a past defocus amount,

Def(t+Δt)=Def(t)+(Def(t)−Def(t−Δt)). (4)

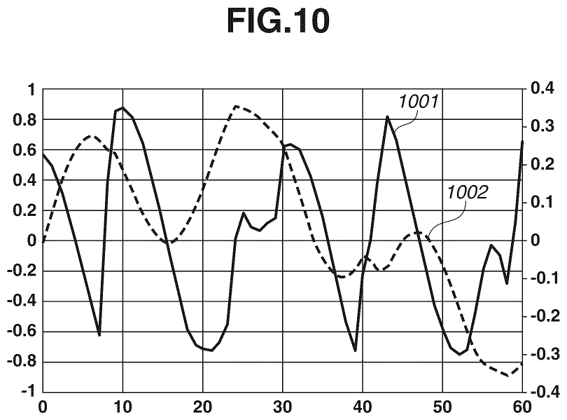

Next, a temporal change in a depth difference among the objects and a temporal change in the focus lens position are calculated from the defocus amounts of the respective objects. FIG. 10 is a conceptual diagram illustrating the temporal change in the depth difference among the objects and the temporal change in the focus lens position. In FIG. 10, a waveform 1001 indicates the temporal change in the depth difference, and a waveform 1002 indicates the temporal change in the focus lens position. A depth difference DefRange(t+Δt) among the objects and the focus lens position DefCenter(t+Δt), which corresponds to the focus center position, at time T=t+Δt are calculated using the following equations (5) and (6):

DefRange(t+Δt)=max(Def1(t+Δt),Def2(t+Δt),Def3(t+Δt))−min(Def1(t+Δt),Def2(t+Δt),Def3(t+Δt)), and (5)

DefCenter(t+Δt)=(max(Def1(t+Δt),Def2(t+Δt),Def3(t+Δt))+min(Def1(t+Δt),Def2(t+Δt),Def3(t+Δt))/2. (6)

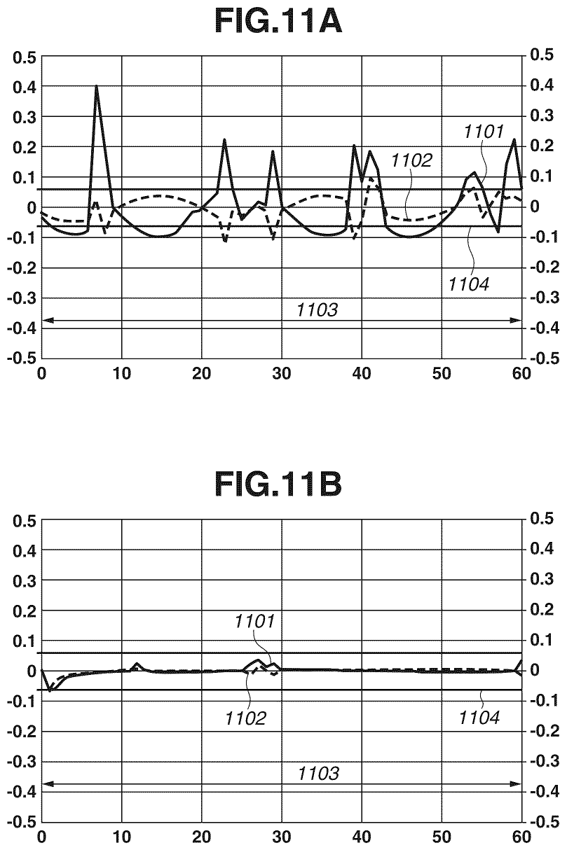

Next, accelerations (rates of changes) of the depth difference and the focus lens position are calculated. FIGS. 11A and 11B are conceptual diagrams illustrating temporal changes in the accelerations of the depth difference among the objects and the focus lens position. In FIGS. 11A and 11B, a waveform 1101 indicates the temporal change in the acceleration of the depth difference, a waveform 1102 indicates the temporal change of the acceleration of the focus lens position, a period 1103 corresponds to a vibration determination period, and a range 1104 corresponds to a dead zone. The acceleration is calculated by taking the second-order derivative with respect to time of the depth difference DefRange and the focus lens position DefCenter shown in the equations (5) and (6).

Next, determination of the vibration state is performed. In the exemplary embodiment, the number of times of sign inversion in the temporal change in the acceleration of the depth difference or the focus lens position is counted. In a case where the number of times of sign inversion in the vibration determination period that is a predetermined time is greater than or equal to a predetermined number of times, it is determined as a vibration state. However, if the number of times of sign inversion is simply counted, those caused by noise in acceleration change are also counted, which may lead to an overestimation of the vibration state. Therefore, a dead zone may be provided as noise countermeasures.

The above-described method of determining the vibration state is more specifically described with reference to FIGS. 11A and 11B.

FIG. 11A illustrates examples of temporal changes in accelerations in a case where it is determined as the vibration state, and FIG. 11B illustrates examples of temporal changes in accelerations in a case where it is not determined as the vibration state.

In the example illustrated in FIG. 11A, during the vibration determination period 1103, the numbers of times the accelerations exceed the dead zone 1104 the number of times of sign inversion are greater than or equal to the predetermined number of times (e.g., five or more), and therefore, the acceleration of the depth difference and the acceleration of the focus lens position are both determined to be in the vibration state.

In the example illustrated in FIG. 11B, during the vibration determination period 1103, the accelerations do not exceed the dead zone 1104. Therefore, the acceleration 1101 of the depth difference and the acceleration 1102 of the focus lens position are both determined to be not in the vibration state. As described above, when the vibration determination is performed based on only the sign of the acceleration, the sign inversion may be determined in an overestimated manner due to the influence of noise. Therefore, by providing the dead zone in the sign determination as described above, the sign inversion can be determined with high accuracy.

Further, in addition to setting of the dead zone, a filter which has a lowpass effect on the temporal change in the acceleration of the depth difference or the focus lens position is applied to suppress noise. At this time, the frequency band for noise suppression is different between a case where the frequency of the temporal change is large and a case where the frequency of the temporal change is small depending on the motions of the objects. Thus, a filter having responsiveness corresponding to the frequency of the temporal change may be applied. In a case where the frequency is large, a filter having a short tap length and high responsiveness is applied, whereas in a case where the frequency is small, a filter having a long tap length and low responsiveness is applied. Further, instead of applying the filter for the temporal change in the acceleration of the depth difference or the focus lens position, the filter may be applied at the stage of the temporal change in the defocus amount or the temporal change in the depth difference or the focus lens position. This improves the robustness of the determination accuracy of the vibration state with respect to the motions of the objects.

### <Switching of Aperture Control Method>

In a case where the depth difference is not oscillating, excessive stopping-down of the aperture may be suppressed by controlling the aperture to follow the depth change so as to achieve a sufficient depth of field. The reason why the suppression of the excessive stopping-down of the aperture is to be performed is because, when stopping-down of the aperture is performed, the image becomes dark, and thus, it is necessary to increase ISO sensitivity or to increase an accumulation time in order to maintain proper exposure. When the ISO sensitivity is increased, an amount of noise is increased, which leads to degradation in the quality of a still image and a moving image. Furthermore, when the accumulation time is increased, blurring of a moving object easily occurs.

In contrast, in a case where the depth difference is oscillating, when the aperture is controlled to follow the depth change, luminance flicker occurs, and the quality of a still image and a moving image can be degraded severely compared to the degradation of the quality caused by the excessive stopping-down of the aperture. Therefore, in the case where the depth difference is oscillating, the aperture control may be performed instead of causing the aperture to follow the depth change. However, in one embodiment, the aperture may be changed only in the dark direction (i.e., darker aperture settings) so as to capture a group of objects within the same depth.

Therefore, the imaging apparatus according to the exemplary embodiment includes the following two depth control methods.
(1) First depth control method: the aperture value is changeable in both the bright direction (i.e., brighter aperture settings) and the dark direction
(2) Second depth control method: the aperture value is changeable only in the dark direction
   In the case where the temporal change in the depth difference is oscillatory, selecting the second depth control method makes it possible to suppress the vibration of the aperture.

### <Switching of Focus Lens Position Control Method>

In a case where the focus lens position is not vibratory, the excessive stopping-down of the aperture may be suppressed by setting the focus lens position to the focus center of a group of objects and focusing on the entire group of objects with a minimum stopping-down amount.

In contrast, in a case where the focus lens position is vibratory, when the focus lens position is caused to follow the focus center of the group of objects, an imaging angle of view and the degree of blur change in an oscillatory manner, and the quality of a still image and a moving image can be degraded severely compared to the deterioration of the quality caused by the excessive stopping-down of the aperture. Therefore, in the case where the focus lens position is vibratory, the focus lens position may be set so as to focus on a main object.

The imaging apparatus according to the exemplary embodiment includes the following two focus lens position control methods.
(1) First focus control method: the focus lens position is controlled to the focus center position among the plurality of objects
(2) Second focus control method: the focus lens position is controlled to focus on the main object among the plurality of objects
   In the case where the temporal change in the focus lens position is oscillatory, selecting the second focus control method makes it possible to suppress the vibration of the focus lens position.

### <Description of Switching Processing of Depth Control Method and Focus Control Method>

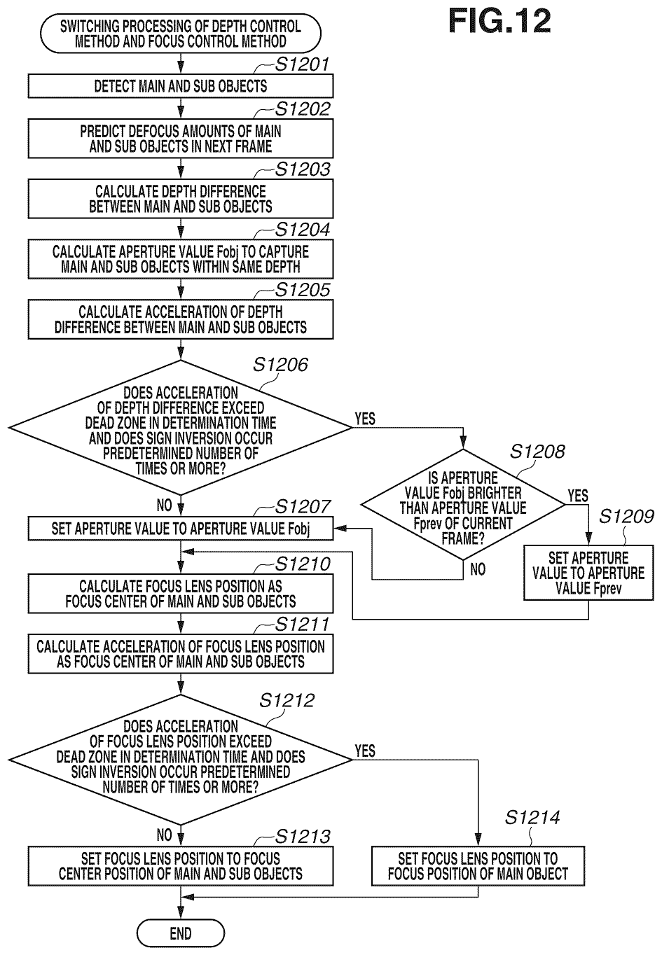

A flow for switching the depth control method and the focus control method according to the exemplary embodiment is described with reference to FIG. 12.

In step S1201, main and sub objects are detected from an image. In step S1202, defocus amounts of the main and sub objects after a predetermined time is elapsed, for example, in a next frame, are predicted based on time history information on the defocus amounts.

In subsequent steps S1203 to S1209, the depth control method is switched.

In step S1203, a depth difference between the main and sub objects is calculated based on the predicted defocus amounts. In addition, time history information on the depth difference up to the current frame is also held.

In step S1204, an aperture value Fobj to capture the main and sub objects within the same depth in a next frame is calculated. In step S1205, an acceleration of the depth difference is calculated using the depth difference between the main and sub objects obtained in step S1203. In addition, time history information on the acceleration of the depth difference up to the current frame is also held.

In step S1206, the oscillatory state of the temporal change in the depth difference is determined by referring to the time history information on the acceleration of the depth difference in the vibration determination time. At this time, the filter processing having the lowpass processing effect is performed on the time history information on the acceleration of the depth difference. Alternatively, a plurality of types of statistical processing is used.

In a case where the acceleration of the depth difference does not exceed the dead zone or the number of times of sign inversion is less than a predetermined number of times in the vibration determination time (NO in step S1206), it is determined that the depth difference is not in the oscillatory state, and the processing proceeds to step S1207.

In a case where the acceleration of the depth difference exceeds the dead zone and the number of times of sign inversion is greater than or equal to the predetermined number of times in the vibration determination time (YES in step S1206), it is determined that the depth difference is in the oscillatory state, and the processing proceeds to step S1208.

In step S1207, the aperture value is set to the aperture value Fobj.

In step S1208, in a case where the aperture value Fobj is darker than an aperture value Fprev of the current frame (NO in step S1208), the processing proceeds to step S1207. In a case where the aperture value Fobj is brighter than the aperture value Fprev of the current frame (YES in step S1208), the processing proceeds to step S1209.

In step S1209, the aperture value is set to the aperture value Fprev.

In subsequent steps S1210 to S1214, the focus control method is switched.

In step S1210, the focus lens position as the focus center of the main and sub objects is calculated based on the predicted defocus amounts. In addition, time history information on the focus lens position up to the current frame is also held.

In step S1211, the acceleration of the focus lens position is calculated using the focus lens position obtained in step S1210. In addition, time history information on the acceleration of the focus lens position up to the current frame is also held.

In step S1212, the oscillatory state of the temporal change in the focus lens position is determined by referring to the time history information on the acceleration of the focus lens position in the vibration determination time. At this time, the filter processing having the lowpass processing effect is performed on the time history information on the acceleration of the focus lens position. Alternatively, a plurality of types of statistical processing is used.

In a case where the acceleration of the focus lens position does not exceed the dead zone or the number of times of sign inversion is less than a predetermined number of times in the vibration determination time (NO in step S1212), it is determined that the focus lens position is not in the vibration state, and the processing proceeds to step S1213.

In a case where the acceleration of the focus lens position exceeds the dead zone and the number of times of sign inversion is greater than or equal to the predetermined number of times in the vibration determination time (YES in step S1212), it is determined that the focus lens position is in the vibration state, and the processing proceeds to step S1214.

In step S1213, the focus lens position is set to the focus center position of the main and sub objects.

In step S1214, the focus lens position is set to the focus position of the main object.

In the exemplary embodiment, switching determination is performed on both the depth control method and the focus control method; however, switching of one of the control methods may be determined.

The method of detecting the oscillatory/vibration state of at least one of the depth difference and the focus lens position, and automatically switching at least one of the depth control method and the focus control method is described above.

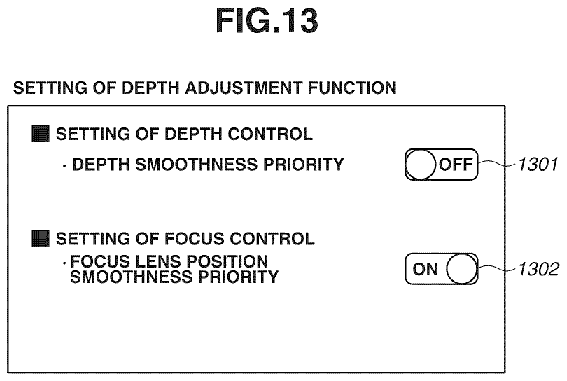

The user may directly designate an imaging mode from a menu screen of the camera or the like, and the control method may be selected based on the designated imaging mode. FIG. 13 illustrates a display example of the menu screen of the camera for designating the imaging mode. In FIG. 13, a button 1301 is a button for switching an imaging mode of “depth smoothness priority” corresponding to switching of the depth control method, and a button 1302 is a button for switching an imaging mode of “focus lens position smoothness priority” corresponding to switching of the focus control method. In a case where the button 1301 is set to OFF, the above-described first depth control method (the aperture value is changeable in both the bright direction and the dark direction) is selected. In contrast, in a case where the button 1301 is set to ON, the above-described second depth control method (the aperture value is changeable only in the dark direction) is selected. In a case where the button 1302 is set to OFF, the above-described first focus control method (the focus lens position is controlled to the focus center position among a plurality of objects) is selected. In contrast, in a case where the button 1302 is set to ON, the above-described second focus control method (the focus lens position is controlled to focus on the main object among the plurality of objects) is selected. Further, ON/OFF switching is not limited to a touch operation of the switch, and audio input or line-of-sight input may be used. As described above, the user directly designates the imaging mode, and the depth control method or the focus control method is selected in association with the designated imaging mode, which makes it possible to perform depth control and focus control intended by the user.

According to the exemplary embodiment, it is possible to provide the imaging apparatus that can acquire a still image and a moving image with suppressed degradation in image quality even in the case where the temporal change in the depth difference or the focus center position among the plurality of objects is oscillatory.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-153659, filed Sep. 6, 2024, which is hereby incorporated by reference herein in its entirety.

What is claimed is:

1. An apparatus comprising,
one or more processors that execute a program stored in a memory and thereby function as:
a calculation unit configured to calculate depth difference information between a plurality of objects; and
a depth control unit configured to control an aperture based on the depth difference information,
wherein the depth control unit switches an aperture control method based on whether a temporal change in the depth difference information is in an oscillatory state.

2. The apparatus according to claim 1,
wherein the one or more processors further function as:
an acquisition unit configured to acquire positional information about the plurality of objects in a depth direction; and
a focus control unit configured to control a focus lens position based on the positional information in the depth direction, and
wherein the focus control unit switches a focus lens position control method based on whether a temporal change in a focus center position based on the positional information in the depth direction is in an oscillatory state.

3. The apparatus according to claim 1, wherein the depth control unit includes, as aperture control methods, a first depth control method in which the aperture value is changeable in both a bright direction and a dark direction, and a second depth control method in which the aperture value is changeable only in the dark direction.

4. The apparatus according to claim 2, wherein the focus control unit includes, as focus lens position control methods, a first focus control method in which the focus lens position is controlled to the focus center position between the plurality of objects, and a second focus control method in which the focus lens position is controlled to focus on any of the plurality of objects.

5. The apparatus according to claim 3, wherein, in a case where the temporal change in the depth difference information is in the oscillatory state, the depth control unit selects the second control method.

6. The apparatus according to claim 4, wherein, in a case where the temporal change in the focus center position based on the positional information in the depth direction is in the oscillatory state, the focus control unit selects the second focus control method.

7. The apparatus according to claim 5, wherein the case where the temporal change in the depth difference information is in the oscillatory state is a state where an aperture value in a case where the aperture is controlled to follow a depth change alternately changes between the bright direction and the dark direction.

8. The apparatus according to claim 6, wherein the case where the temporal change in the focus center position based on the positional information in the depth direction is in the oscillatory state is a state where the focus center position based on the positional information in the depth direction alternately changes between a closest distance side and an infinite distance side.

9. The apparatus according to claim 5, wherein the case where the temporal change in the depth difference information is in the oscillatory state is a state where a sign of an acceleration of the depth difference information changes a predetermined number of times or more in a predetermined time.

10. The apparatus according to claim 6, wherein the case where the temporal change in the focus center position based on the positional information in the depth direction is in the oscillatory state is a state where a sign of an acceleration of information on the focus center position based on the positional information in the depth direction changes a predetermined number of times or more in a predetermined time.

11. The apparatus according to claim 9, wherein the acceleration of the depth difference information is calculated using a plurality of types of filter processing having a lowpass processing effect or a plurality of types of statistical processing.

12. The apparatus according to claim 10, wherein the acceleration of the information on the focus center position based on the positional information in the depth direction is calculated using a plurality of types of filter processing having a lowpass processing effect or a plurality of types of statistical processing.

13. The apparatus according to claim 1,
wherein the one or more processors further function as a detection unit configured to detect the plurality of objects from an image, and
wherein the depth control unit controls the aperture to settle the plurality of objects detected from the image, within a depth of field.

14. The apparatus according to claim 1,
wherein the one or more processors further function as a prediction unit configured to acquire a predicted result of positions of the plurality of objects in a depth direction after a predetermined time is elapsed, and
wherein the depth control unit controls the aperture based on the predicted result.

15. The apparatus according to claim 2,
wherein the one or more processors further function as a prediction unit configured to acquire a predicted result of positions of the plurality of objects in the depth direct after a predetermined time is elapsed, and
wherein the focus control unit controls the focus lens position based on the predicted result.

16. The apparatus according to claim 1, wherein the depth control unit switches the aperture control method based on a mode set by a user.

17. The apparatus according to claim 2, wherein the focus control unit switches the focus lens position control method based on a mode set by a user.

18. An apparatus comprising
one or more processors that execute a program stored in a memory and thereby function as:
a calculation unit configured to calculate depth difference information between a plurality of objects;
a depth control unit configured to control an aperture based on the depth difference information;
an acquisition unit configured to acquire positional information about the plurality of objects in a depth direction; and
a focus control unit configured to control a focus lens position based on the positional information in the depth direction,
wherein the depth control unit switches an aperture control method based on whether a temporal change in the depth difference information is in an oscillatory state, and
wherein the focus control unit switches a focus lens position control method based on whether a temporal change in a focus center position based on the positional information in the depth direction is in an oscillatory state.

19. The apparatus according to claim 18, wherein the focus control unit includes, as focus lens position control methods, a first focus control method in which the focus lens position is controlled to the focus center position between the plurality of objects, and a second focus control method in which the focus lens position is controlled to focus on any of the plurality of objects.

20. The apparatus according to claim 19, wherein, in a case where the temporal change in the focus center position based on the positional information in the depth direction is in the oscillatory state, the focus control unit selects the second focus control method.

21. The apparatus according to claim 20, wherein the case where the temporal change in the focus center position based on the positional information in the depth direction is in the oscillatory state is a state where the focus center position based on the positional information in the depth direction alternately changes between a closest distance side and an infinite distance side.

22. The apparatus according to claim 20, wherein the case where the temporal change in the focus center position based on the positional information in the depth direction is in the oscillatory state is a state where a sign of an acceleration of information on the focus center position based on the positional information in the depth direction changes a predetermined number of times or more in a predetermined time.

23. The apparatus according to claim 22, wherein the acceleration of the information on the focus center position based on the positional information in the depth direction is calculated using a plurality of types of filter processing having a lowpass processing effect or a plurality of types of statistical processing.

24. The apparatus according to claim 18,
wherein the one or more processors further function as a detection unit configured to detect the plurality of objects from an image, and
wherein the depth control unit controls the aperture to capture the plurality of objects detected from the image, within a depth of field.

25. A method of controlling an apparatus, the method comprising:
calculating depth difference information between a plurality of objects; and
controlling an aperture based on the depth difference information,
wherein, in the controlling, an aperture control method is switched based on whether a temporal change in the depth difference information is in an oscillatory state.

26. A method of controlling an apparatus, the method comprising:
acquiring positional information on a plurality of objects in a depth direction; and
controlling a focus lens position based on the positional information in the depth direction,
wherein, in the controlling, a focus lens position control method is switched based on whether a temporal change in a focus center position based on the positional information in the depth direction is in an oscillatory state.

27. A method of controlling an apparatus, the method comprising:
calculating depth difference information between a plurality of objects;
controlling an aperture based on the depth difference information;
acquiring positional information on the plurality of objects in a depth direction; and
controlling a focus lens position based on the positional information in the depth direction,
wherein, in the controlling of the aperture, an aperture control method is switched based on whether a temporal change in the depth difference information is in an oscillatory state, and
wherein, in the controlling of the focus lens position, a focus lens position control method is switched based on whether a temporal change in a focus center position based on the positional information in the depth direction is in an oscillatory state.

28. A non-transitory computer-readable storage medium that stores a program for causing a computer to execute the method according to claim 25.

29. A non-transitory computer-readable storage medium that stores a program for causing a computer to execute the method according to claim 26.

30. A non-transitory computer-readable storage medium that stores a program for causing a computer to execute the method according to claim 27.
